(19) United States
(12) Patent Application Publication
(10) Pub. No.: US 2008/0242211 A1
(43) Pub. Date: Oct. 2, 2008

(54) HIGH VOLTAGE BATTERY WITH A PULLING VENTILATOR IN A FUEL CELL VEHICLE

(76) Inventors: Franz Winter, Mainz (DE); Andreas Koenekamp, Darmstadt (DE); Michael J. Gorman, Pinckney, MI (US)

Correspondence Address: FRASER CLEMENS MARTIN & MILLER LLC, 28366 KENSINGTON LANE, PERRYSBURG, OH, 43551-4163, US

(21) Appl. No.: 11/694,376

(22) Filed: Mar. 30, 2007

(51) Int. Cl. B60H 1/26

(52) U.S. Cl. 454/141; 454/237

(57) ABSTRACT

A method and apparatus are disclosed for a vehicle, the apparatus having a pulling ventilator, wherein the ventilator minimizes a temperature in a housing while minimizing a noise level in a passenger compartment of the vehicle.

### FIELD OF THE INVENTION

The present disclosure relates to a method and apparatus for operation of an energy source and, more particularly, to a method and apparatus for ventilating the energy source.

### BACKGROUND OF THE INVENTION

In various fields and industries, energy sources are widely used. Fuel cell systems are being proposed as a replacement for many traditional energy sources. In particular, automotive manufacturers have designed and developed vehicles that use fuel cell systems as an economical and environmentally friendly alternative to an internal combustion engine. In a typical fuel cell vehicle, fuel cells generate electricity through an electrochemical reaction between hydrogen and oxygen to charge batteries or to provide power for an electric motor.

Fuel cell vehicles that utilize a battery require a cooling system to control a temperature of the battery and prevent damage thereto. The cooling system is necessary because the battery generates heat during a charging and discharging thereof. Specifically, when fuel cell vehicles travel at slower speeds or are idle, a sufficient flow of external air is not provided to flow over and around the battery and maintain a desired temperature level. Thus, it is necessary to induce a flow of air to cool the battery. Typically, a battery ventilator is used to induce the flow of air. The battery ventilator typically draws air from a passenger compartment of the vehicle. Often, an opening under the driver's seat is used. The ventilator then “pushes” the air downstream through a conduit to the battery or a battery compartment. The battery ventilator normally includes a ventilator fan and a housing.

The battery ventilator is typically between the opening from the passenger compartment and the battery. The close proximity of the battery ventilator to the opening from the passenger compartment exposes passengers in the passenger compartment of the vehicle to noise emitted by the fan, and to noise caused by the air being drawn into the opening. The noise exposure is contrary to an objective of automobile manufacturers to minimize the noise entering the passenger compartment of the vehicle.

It would be desirable to develop a method and apparatus for ventilating an energy source that is compliant with a desired noise level, and militates against damage to or a shortening of a life of the energy source, and which is simple to manufacture and install.

### SUMMARY OF THE INVENTION

In concordance and agreement with the present invention, a method and apparatus for ventilating an energy source that is compliant with a desired noise level and militates against damage to or a shortening of a life of the energy source, and which is simple to manufacture and install, has surprisingly been discovered.

In one embodiment, the method for ventilating an energy source comprises the steps of providing a source of fluid; providing a ventilator; providing a housing for an energy source, the housing having an inlet and an outlet formed therein, the inlet in fluid communication with the source of fluid and the outlet in fluid communication with the ventilator; and causing a fluid to flow from the source of fluid, through the housing, and through the ventilator to ventilate the housing.

In another embodiment, a method for ventilating an energy source in a fuel cell system comprises the steps of providing a ventilator; providing a housing for an energy source, the housing having an inlet and an outlet formed therein, the inlet in fluid communication with a passenger compartment of a vehicle and the outlet in fluid communication with the ventilator; and causing air to flow from the passenger compartment of the vehicle, through the housing, and through the ventilator to ventilate the housing.

In another embodiment, an apparatus for ventilating an energy source in a fuel cell system comprises a source of fluid; a housing for the energy source, the housing having an inlet and an outlet formed therein, the inlet in fluid communication with the source of fluid; a ventilator in fluid communication with the outlet of the housing, wherein the ventilator causes a fluid, from the source of fluid, to flow through the housing to ventilate the housing.

A method and apparatus for ventilating an energy source for a fuel cell system is particularly useful for cooling a high voltage battery in a fuel cell vehicle.

### DRAWINGS

The above, as well as other advantages of the present invention, will become readily apparent to those skilled in the art from the following detailed description, particularly when considered in the light of the accompanying drawings described in which:

FIG. 1 is a bottom plan view of a fuel cell vehicle including an apparatus for ventilating an energy source according to an embodiment of the invention;

FIG. 2 is an enlarged top plan view of the apparatus for ventilating the energy source in the fuel cell system illustrated in FIG. 1;

FIG. 3 is a top plan view of a passenger compartment of the fuel cell vehicle illustrated in FIG. 1 having an aperture formed in a driver's side thereof; and

FIG. 4 is a schematic flow diagram illustrating a flow of air for the apparatus for ventilating the energy source in the fuel cell system illustrated in FIGS. 1-3.

### DETAILED DESCRIPTION OF THE INVENTION

The following detailed description and appended drawings describe and illustrate various exemplary embodiments of the present invention. The description and drawings serve to enable one skilled in the art to make and use the invention, and are not intended to limit the scope of the invention in any manner. It is understood that materials other than those described can be used without departing from the scope and spirit of the invention. In respect of the methods disclosed, the steps presented are exemplary in nature, and thus, are not necessary or critical. Although use with a fuel cell system is disclosed herein for exemplary purposes, it is understood that the invention can be used otherwise as desired such as for any energy source, for example.

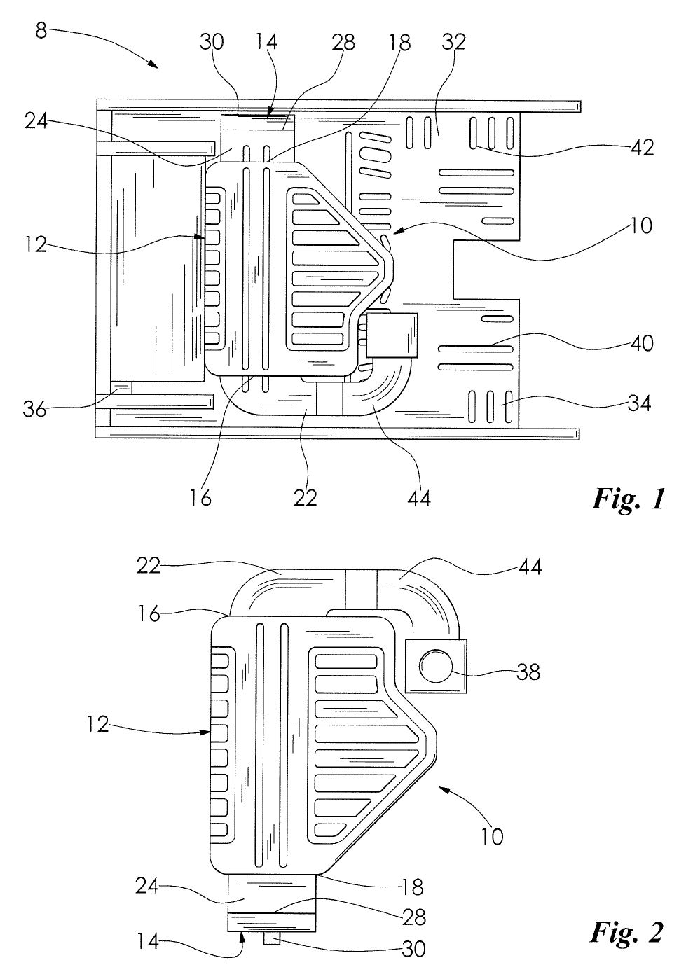

FIG. 1 depicts a fuel cell vehicle 8 having an apparatus for ventilating and cooling an energy source 10 for a fuel cell system (not shown), although the apparatus 10 can be used for ventilating and cooling other elements and systems, as desired, such as the fuel cell system and other components thereof, for example. In the embodiment shown, the apparatus 10 is adapted for use in a fuel cell vehicle 8 having a high voltage battery (not shown) for energy storage. It is understood that the apparatus 10 may be used with other fuel cell systems and other energy sources, as desired, without departing from the scope and spirit of the invention. The apparatus 10 may be centrally disposed on an underbody 32 of the fuel cell vehicle 8. However, the apparatus 10 can be disposed on an anterior end 34 or a posterior end 36 of the vehicle 8 if desired.

FIG. 2 shows the apparatus for ventilating an energy source 10 for the fuel cell system. The apparatus 10 includes a housing 12 and a ventilator 14. A hollow compartment (not shown) is formed in the housing 12 and is adapted to enclose an energy source (not shown) such as a battery, for example. The housing 12 may be made of any conventional material such as polypropylene, for example. In the embodiment shown, the housing 12 has a substantially rectangular shape. However, it is understood that the housing 12 can have other shapes as desired.

The housing 12 includes an inlet section 16 and an outlet section 18 formed therein. In the embodiment shown, the inlet section 16 and the outlet section 18 are formed on opposing ends of the housing 12. The inlet section 16 is formed on an upstream side of the housing 12 and the outlet section 18 is formed on a downstream side of the housing 12. It is understood that the inlet section 16 and the outlet section 18 may be formed elsewhere on the housing 12, if desired.

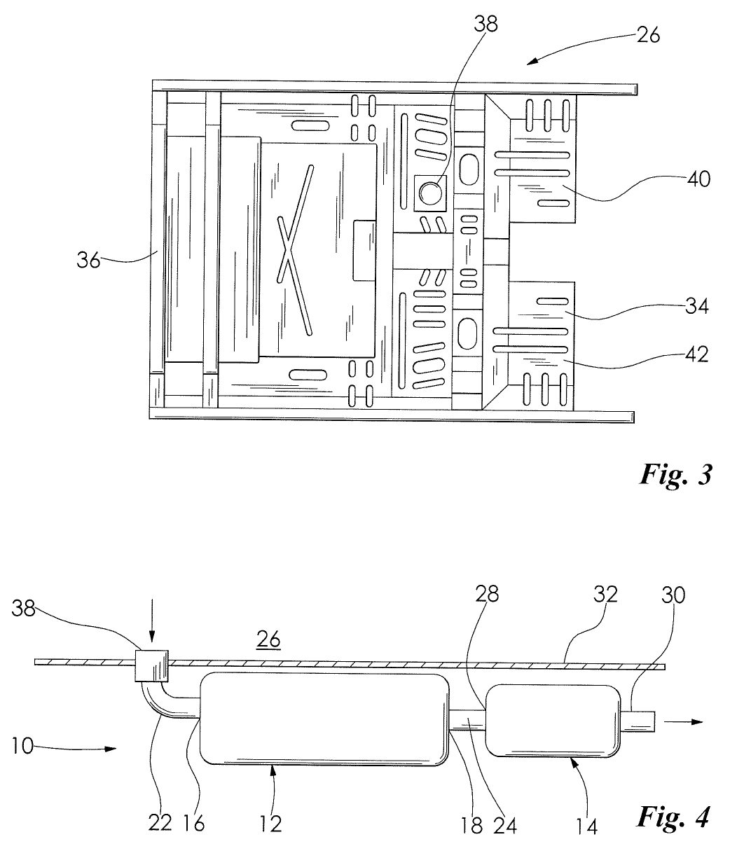

The inlet section 16 is in fluid communication with a source of fluid such as a passenger compartment 26 illustrated in FIGS. 3 and 4, through an inlet conduit 22. The outlet section 18 is in fluid communication with the ventilator 14 through an outlet conduit 24. In the embodiment shown, the inlet conduit 22 is disposed adjacent to a driver's side of the housing 12. However, other locations can be used as desired. The inlet conduit 22 may be produced from any conventional material such as polypropylene, for example. Although a substantially rectangular cross-sectional shape is shown, other cross-sectional shapes can be used for the inlet conduit 22. Further, the inlet conduit 22 may have one or more contours 44 as needed. The outlet conduit 24 may be produced from any conventional materials such as polypropylene, for example. In the embodiment shown, the outlet conduit 24 has a substantially rectangular cross-section. It is understood that the outlet conduit 24 can have other cross-sectional shapes. To facilitate fluid flow, the outlet conduit 24 may have one or more contours 44.

The ventilator 14 includes a fluid transfer device (not shown). It is understood that the fluid transfer device can be any conventional fluid transfer device known in the art such as a fan, a pump, or a turbine, for example. The ventilator 14 may be produced from any conventional material such as polypropylene, for example. In the embodiment shown in FIG. 2, the ventilator 14 has a substantially cylindrical shape. It is understood that the ventilator 14 can have other shapes as desired.

An inlet 28 and an outlet 30 are formed in the ventilator 14. The inlet 28 is formed on an upstream side of the ventilator 14 and the outlet 30 is formed on a downstream side of the ventilator 14. It is understood that the inlet 28 and the outlet 30 may be formed elsewhere on the ventilator 14, if desired. The inlet 28 is in fluid communication with the housing 12 through the outlet conduit 24. The ventilator 14 can be in direct fluid communication with the housing 12, if desired. The outlet 30 is in fluid communication with the atmosphere. However, the outlet 30 may be connected to a contaminant treatment system or other system or element.

As illustrated in FIG. 3, the source of fluid is a passenger compartment 26 of the fuel cell vehicle 8. It is understood that other sources of fluid may be used as desired. In the embodiment shown, the passenger compartment 26 includes a driver's side 40 and a passenger's side 42. The driver's side 40 includes an aperture 38 formed therein. It is understood that the aperture 38 may have any desired shape or dimension, which allows sufficient fluid flow and may be disposed elsewhere in the passenger compartment 26.

FIG. 4 depicts a schematic flow diagram of a flow of air for the apparatus 10. The flow diagram shows the housing 12 in fluid communication with the passenger compartment 26 and the ventilator 14 through the conduits 22, 24.

It is desirable for the apparatus 10 to be installed to maximize a distance between the aperture 38 and the ventilator 14. The apparatus 10 can be assembled using commonly known joining methods such as fasteners, clips, epoxy, and the like, for example.

In operation, the ventilator 14 causes the fluid, typically air, to flow from the passenger compartment 26, through the aperture 38, into the inlet conduit 22, and through the housing 12. Once the fluid has flowed through the housing 12, the fluid flows to the ventilator 14 through the outlet conduit 24. The fluid is then exhausted from the ventilator 14 to the atmosphere or other system or element as desired. Due to the flow of air though the housing 12, a temperature in the housing 12 is maintained at or about a temperature of the passenger compartment 26 or other source of fluid. Additionally, since the distance between the aperture 38 and the ventilator 14 is maximized, noise entering the passenger compartment 26 or other source of fluid from the ventilator is minimized.

While certain representative embodiments and details have been shown for purposes of illustrating the invention, it will be apparent to those skilled in the art that various changes may be made without departing from the scope of the disclosure, which is further described in the following appended claims.

What is claimed is:

1. A method for ventilating an energy source, the method comprising the steps of:
providing a source of fluid;
providing a ventilator;
providing a housing for an energy source, the housing having an inlet and an outlet formed therein, the inlet in fluid communication with the source of fluid and the outlet in fluid communication with the ventilator; and
causing a fluid to flow from the source of fluid, through the housing, and through the ventilator to ventilate the housing.

2. The method according to claim 1, including the step of providing an inlet conduit providing fluid communication between the source of fluid and the inlet of the housing.

3. The method according to claim 2, including the step of providing an outlet conduit providing fluid communication between the outlet of the housing and the ventilator.

4. The method according to claim 1, wherein the source of fluid is a passenger compartment of a vehicle.

5. The method according to claim 1, wherein the fluid is air.

6. The method according to claim 1, wherein the fluid from the source of fluid facilitates control of a temperature in the housing.

7. The method according to claim 1, wherein the ventilator has an inlet and an outlet formed therein.

8. The method according to claim 7, wherein the outlet of the ventilator is in fluid communication with the atmosphere.

9. A method for ventilating an energy source in a fuel cell system, the method comprising the steps of:
providing a ventilator;
providing a housing for an energy source, the housing having an inlet and an outlet formed therein, the inlet in fluid communication with a passenger compartment of a vehicle and the outlet in fluid communication with the ventilator; and
causing air to flow from the passenger compartment of the vehicle, through the housing, and through the ventilator to ventilate the housing.

10. The method according to claim 9, including the step of providing an inlet conduit providing fluid communication between the passenger compartment of the vehicle and the inlet of the housing.

11. The method according to claim 10, including the step of providing an outlet conduit providing fluid communication between the outlet of the housing and the ventilator.

12. The method according to claim 9, wherein the air from the passenger compartment of the vehicle facilitates control of a temperature in the housing.

13. The method according to claim 9, wherein the outlet of the ventilator is in fluid communication with the atmosphere.

14. An apparatus for ventilating an energy source in a fuel cell system comprising:
a source of fluid;
a housing for the energy source, the housing having an inlet and an outlet formed therein, the inlet in fluid communication with the source of fluid;
a ventilator in fluid communication with the outlet of the housing, wherein the ventilator causes a fluid, from the source of fluid, to flow through the housing to ventilate the housing.

15. The apparatus according to claim 14, wherein the fluid is air.

16. The apparatus according to claim 14, wherein the source of fluid is a passenger compartment of a vehicle.

17. The apparatus according to claim 14, wherein the fluid from the source of fluid facilitates a control of a temperature in the housing.

18. The apparatus according to claim 14, including an inlet conduit providing fluid communication between the source of fluid and the inlet of the housing.

19. The apparatus according to claim 18, including an outlet conduit providing fluid communication between the outlet of the housing and the ventilator.

20. The apparatus according to claim 14, wherein the ventilator has an inlet and an outlet formed therein, the outlet of the ventilator in fluid communication with the atmosphere.
